(19) United States
(12) Patent Application Publication
(10) Pub. No.: US 2009/0020400 A1
(43) Pub. Date: Jan. 22, 2009

(54) Drive Arrangement with a Drive Device of an Electrical Switching Device and Method for Operating the Drive Arrangement

(75) Inventors: Christian Haster, Falkensee (DE); Wojciech Olszewski, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 11/916,846

(22) PCT Filed: May 23, 2006
(86) PCT No.: PCT/EP06/62516

§ 371 Date: Dec. 7, 2007

(30) Foreign Application Priority Data
Jun. 7, 2005 (DE) 10 2005 027 016.6

(51) Int. Cl. H01H 3/20

(52) U.S. Cl. 200/331

(57) ABSTRACT

A drive configuration with a drive device is connected via a connecting element to a plurality of moving contact makers of a number of switch poles of an electrical switchgear. The drive device can be disconnected from the moving contact makers by way of a clutch.

The invention relates to a drive arrangement with a drive device, which is coupled to a plurality of movable contact pieces of a plurality of switching poles of an electrical switching device by means of at least one connecting element.

Such a drive arrangement is known, for example, from the laid-open specification DE 42 39 419 A1. This document discloses a circuit breaker with a plurality of circuit breaker housings, which are arranged on a mount. The three circuit breaker housings have the form of pole pillars. A drive movement towards the individual pole pillars can be transmitted by means of a coupling rod. The coupling rod can be set in motion by means of a switch drive. Such a construction makes it possible to generate a drive movement in all three pole pillars.

It is not readily possible to implement switching of an individual pole pillar with such an arrangement.

The laid-open specification DE 40 11 443 A1 has disclosed a high-voltage circuit breaker, which has a plurality of drive devices and a plurality of circuit breaker housings. Each of the drive devices is associated with one and only one movable contact piece. This makes it possible to drive individual poles of an electrical switching device in a targeted manner or to switch them with a temporal shift.

Such an arrangement has the disadvantage, however, that the three drive devices make the overall arrangement more expensive.

The object of the invention is to provide a drive arrangement of the type mentioned at the outset which makes flexible control of the movement of the movable switching contact pieces possible.

This is achieved according to the invention in the case of a drive arrangement of the type mentioned at the outset by virtue of the fact that the drive device can be isolated from at least one of the contact pieces by means of a clutch.

By using a common drive device for a plurality of contact pieces, cost advantages in comparison with an arrangement with a plurality of drive devices can be achieved. The use of a switchable clutch now makes it possible to pass on the force flow which can be produced by the drive device in a targeted manner only to selected contact pieces. In order to transfer the movement, corresponding connecting elements are provided. These are, for example, linkage arrangements, gear arrangements, deflecting devices or else cable pulls, chains or the like. Clutches can be used in diverse variants. For example, it is possible to use force-fitting clutches, such as friction disk clutches, interlocking clutches, such as dog clutches, hydraulic clutches, toothed clutches with different types of toothing and further clutches which are suitable depending on the intended use. Such switchable clutches have the advantage of being capable of being switched over quickly from an engaged position into a disengaged position, and vice versa. In a simple case, provision may be made, for example, for a clutch to be actuated manually. It is thus possible to use, by means of the electrical switching device, an individual or a selection of a plurality of switching poles from the total number of switching poles for a switching operation in a targeted manner.

An advantageous configuration may provide that the clutch is an electromagnetically driven clutch.

Electromagnetic driving makes it possible to also operate the clutch remotely. In addition, electromagnetic driving of the clutch makes it possible to include such an arrangement in existing management and control systems. It is advantageous, for example, to produce various clutch states for a short period of time in the case of the electrical switching device being configured as a high-voltage circuit breaker. In this case, it should be possible, sometimes within fractions of seconds, to switch over between various coupling combinations. In a simple example, two coupling elements of the clutch which can be caused to have a force effect on one another can be pressed onto one another using magnetic forces of an electromagnet and thus a coupling point can be closed.

A clutch can also be used, for example, as a securing element in order to prevent switching operations from being carried out. For example, an electrical switching device can thus be prevented from switching on again. In this case, provision may be made for a common clutch to be provided in order to disconnect the movable contact pieces of all switching poles from the drive device.

An advantageous configuration can furthermore provide that each of the contact pieces can be isolated from the drive device via a separately drivable clutch.

The use of a plurality of separately drivable clutches allows for a flexible selection of the respective contact pieces to be moved or not to be moved. Thus, a very wide variety of switching cases can be controlled.

A further advantageous configuration can provide that all of the contact pieces are capable of moving jointly.

The joint movement of all the contact pieces corresponds to the known movement of the movable contact pieces of a plurality of switching poles of an electrical switching device. The clutch or clutches are in the engaged state, so that a force-transmitting connection is provided via the connecting elements from the drive device to the contact pieces. This can be provided, for example, by virtue of the fact that a plurality of or all of the contact pieces are connected to the drive device via a common clutch, or that each individual or a plurality of groups of contact pieces are coupled to the drive device via a plurality of clutches.

Advantageously, provision may furthermore be made for a contact piece of a switching pole to be movable, while the contact pieces of the other switching poles are disengaged from the drive device.

In the case of specific switching operations, provision may be made for switching only to be carried out in a single one of the switching poles, while the contact pieces of the other switching poles remain at rest. In this case, provision may be made for the resting contact pieces to remain in their switched-off position or in their switched-on position. As a result of such an arrangement, for example single-pole short-term interruptions on high-voltage circuit breakers can be implemented.

Advantageously, provision may furthermore be made for optionally a first or a second drive device to be capable of being connected to the movable contact pieces via at least one clutch.

Such a configuration of a drive arrangement makes it possible to provide the first drive device for the joint movement of a plurality of contact pieces of a plurality of switching poles. For this purpose, for example, provision may be made for the first drive device to be coupled to all the contact pieces of the switching poles via a single clutch. However, as an alternative provision may also be made for a plurality of clutches to be used instead of the one clutch.

The second drive device can be used for the purpose of moving only individual contact pieces or individual groups of contact pieces in a targeted manner. For this purpose, corresponding clutches are provided. In order to prevent faulty switching operations, in this case the clutches associated with the first drive device and the clutches associated with the second drive device should be locked with respect to one another. Since, for the joint movement of a plurality of contact pieces, a greater expenditure of energy is required than for the movement of individual contact pieces or a group of contact pieces of an electrical switching device, the first drive needs to be dimensioned so as to be correspondingly larger than the second drive. Overloads of the contact systems of the switching poles in the case of individual switching operations are avoided since switching forces matched to the switching task are introduced by using a plurality of drives with different powers. As a result, the mechanical loading of the electrical switching device during a switching operation is reduced, and the life of the electrical switching device is extended.

When transmitting electrical energy with polyphase AC voltage systems, overhead lines are also used. Owing to external influences, it may arise that temporary damage to the air insulation occurs. This can take place, for example, as a result of falling branches from trees or bird flight. In such a case it is conventional only to disconnect the affected phase for a short period of time in order to provide the air with recombination and reinforcing of the insulating clearance. Then, this phase is reconnected. This process takes place within short time frames usually in automated fashion.

A further object of the invention is to specify a suitable method for operating a switching device with a plurality of movable contact pieces of a plurality of switching poles and a common drive device for moving the contact pieces, the contact pieces being located in their switched-on positions.

In the case of a method of the type mentioned at the outset, the object is achieved by virtue of the fact that one of the contact pieces is moved into its switched-off position, that the other contact pieces remain at rest, decoupled from the drive device, and that the contact piece which has moved into the switched-off position is moved back into the switched-on position.

Owing to the disengagement of the movable contact pieces which are not affected, it is possible to dispense with the use of a plurality of drive devices associated with the respective contact pieces, which is otherwise generally necessary. Cost savings for the electrical switching device can thus be achieved.

Exemplary embodiments of the invention are illustrated schematically in the figures and will be described in more detail in the following text.

In the figures

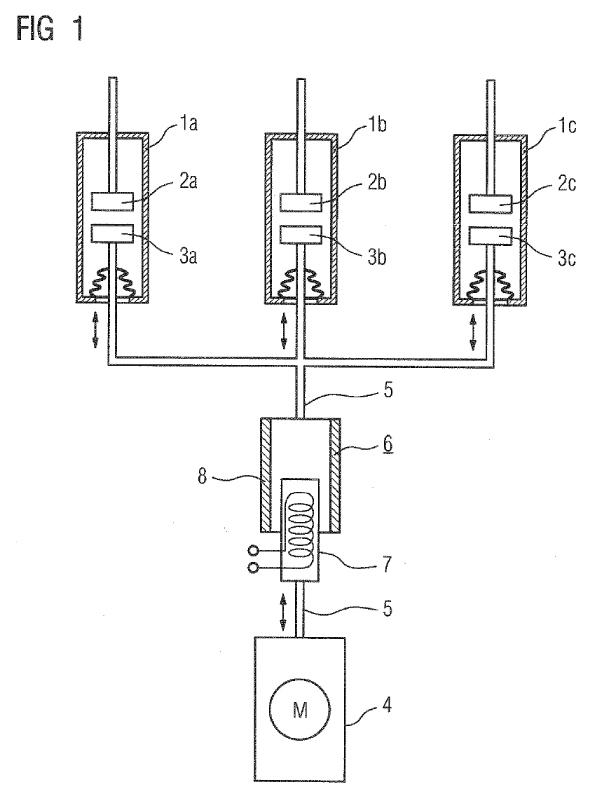

FIG. 1 shows a drive arrangement with a common drive device for the movable contact pieces of a plurality of switching poles, which can be connected to the drive device via a common clutch,

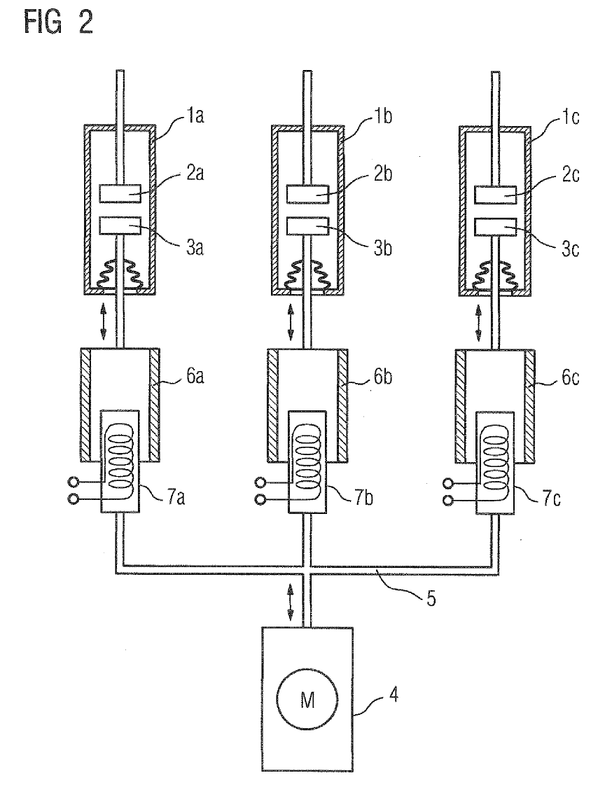

FIG. 2 shows a drive arrangement with a drive device, which can be connected to a plurality of movable contact pieces of a plurality of switching poles via a plurality of clutches,

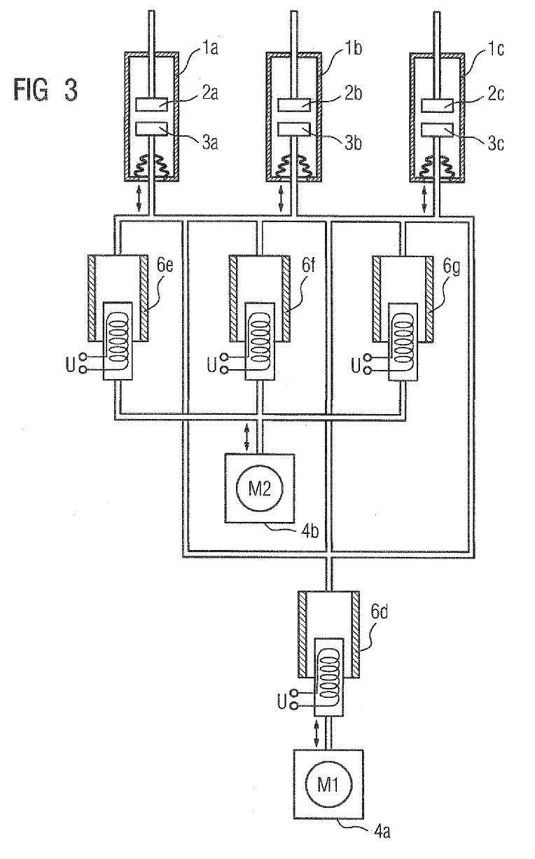

FIG. 3 shows a drive arrangement with a plurality of clutches and a plurality of drive devices, and

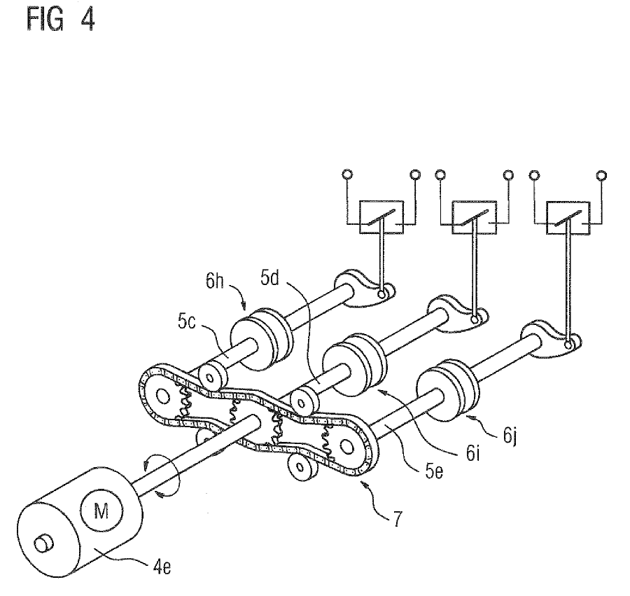

FIG. 4 shows an alternative configuration of a drive arrangement with a plurality of clutches.

In medium-voltage, high-voltage and extra-high-voltage electrical energy transmission systems, polyphase AC voltage systems are generally used. These systems have, for example, three phases, one switching pole 1a, 1b, 1c being provided in the switching device illustrated in FIG. 1 for switching each of the three phases. The switching device illustrated in FIG. 1 and the other figures is a circuit breaker, for example. A circuit breaker is an electrical switching device which can reliably interrupt rated currents and short-circuit currents. However, other switching devices, such as switch disconnectors, load switches etc. can also be provided with the features in accordance with the invention. The circuit breaker illustrated in FIG. 1 has switching poles 1a, 1b, 1c in the form of vacuum interrupters. Alternatively, however, further configuration variants of switching poles can also be used, for example air-insulated switching poles and compressed-gas-insulated switching poles, for example based on sulfur hexafluoride, nitrogen or a mixture of these gases.

The three switching poles 1a, 1b, 1c have an identical design. Each of the three switching poles has a stationary contact piece 2a, 2b, 2c and in each case one associated movable contact piece 3a, 3b, 3c. The stationary contact pieces 2a, 2b, 2c and the movable contact pieces 3a, 3b, 3c are arranged axially opposite one another. In order to produce an electrically conductive connection by means of the switching poles 2a, 2b, 2c, the movable contact pieces 3a, 3b, 3c are displaced in the direction of the stationary contact pieces 2a, 2b, 2c.

In order to cause the movable contact pieces 3a, 3b, 3c to move, a drive device 4 is connected to each of the movable contact pieces 3a, 3b, 3c via connecting elements 5. Linkages, force-converting gears, lever arrangements, shafts etc. can be used as the connecting elements. The connecting element 5 can be interrupted by means of a clutch 6. By way of example, a clutch 6 is illustrated in FIG. 1 which has a plunger armature 7 on the drive side. The plunger armature 7 has an energizable winding passing through it and acts as an electromagnet. In the switched-off state of the switching poles 1a, 1b, 1c (as shown in FIG. 1), the plunger armature 7 only partially protrudes into a sleeve 8, arranged on the output drive side, of the clutch 6. The sleeve 8 is formed from a ferromagnetic material.

In the case of a current flowing through the electrical winding of the plunger armature 7, a force effect occurs between the plunger armature 7 and the sleeve 8, i.e. the clutch 6 is closed. In the closed state, the drive movement produced by the drive device 4 is transmitted to the movable contact pieces 3a, 3b, 3c via the connecting element 5 and the clutch 6.

In order to transfer the drive forces more effectively, provision may be made for the sleeve 8 to be provided with a particular shape or to be only formed partially from a ferromagnetic material. In addition provision may be made for further electromagnets, which may be capable of being connected and disconnected, to also be placed on the sleeve 8 in order to make more effective force transfer possible in the engaged state of the clutch 6.

In the open state of the clutch 6, i.e. no drive forces are transmitted between the plunger armature 7 and the sleeve 8, it is not possible, when a drive movement is emitted by the drive device 4, for the drive movement to be transmitted to the movable contact pieces 3a, 3b, 3c.

Such a clutch 6 can be used, for example, to ensure that any undesired operation of the drive device 4 does not result in a movement of the movable contact pieces 3a, 3b, 3c.

FIG. 2 shows a variant of the arrangement illustrated in FIG. 1. Functionally identical components have been provided with the same reference symbols in the following figures. The three switching poles 1a, 1b, 1c in turn have stationary contact pieces 2a, 2b, 2c and movable contact pieces 3a, 3b, 3c. A drive device 4 is provided for moving the movable contact pieces 3a, 3b, 3c. The drive device 4 is connected to the movable contact pieces 3a, 3b, 3c via a connecting element 5. A separate clutch 6a, 6b, 6c is associated with each of the three movable contact pieces 3a, 3b, 3c. Each of the clutches 6a, 6b, 6c has the same basic design as described in relation to FIG. 1. On the drive side, the plunger armatures 7a, 7b, 7c of the clutches 6a, 6b, 6c are connected to one another. Each individual one of the clutches 6a, 6b, 6c is necessarily capable of being engaged and disengaged. As a result, this arrangement is suitable for moving all the movable contact pieces 3a, 3b, 3c jointly when all the clutches 6a, 6b, 6c are engaged. However, provision may also be made for a temporally staggered engagement of the clutches 6a, 6b, 6c to take place. A temporally staggered connection of the switching poles 1a, 1b, 1c thus takes place. As a result, this arrangement can also be used for carrying out synchronous switch-on or switch-off operations. Synchronous switching is understood to mean phase angle-dependent switching. In a system with AC voltage or alternating current, switching-on or switching-off is triggered at certain times (a current zero crossing, a voltage drop or a voltage maximum or other suitable times) in a targeted manner. Since a phase shift of the oscillating voltages and currents takes place in the three switching poles, in the case of a switching operation of all three switching poles 1a, 1b, 1c a corresponding temporal shift needs to be provided in order to carry out a switching operation in each of the three switching poles 1a, 1b, 1c at the optimum time.

Furthermore, the device illustrated in FIG. 2 is also capable of carrying out single-phase short-term interruptions. In the switched-on state of the three switching poles 1a, 1b, 1c, provision may be made under certain circumstances to switch a switching pole off for a short period of time and then to switch it on again. This is necessary in order to allow certain operations in the system to die out, for example in order to allow for strengthening of an insulating clearance on a phase conductor. For this purpose, starting from a switched-on state of the switching poles 1a, 1b, 1c, the relevant clutch 6a is then engaged and the drive device 4 produces a switch-off movement. The engaged movable contact piece 3a is therefore moved into its switched-off position. Then the movement operation is reversed, and the movable contact piece 3a is again moved back into its switched-on position. The two remaining movable contact pieces 3b, 3c are not moved as well owing to the open clutches 6b, 6c and remain constantly in their switched-on positions.

FIG. 3 shows a development of the arrangement illustrated in FIG. 1. In turn, the arrangement known from FIGS. 1 and 2 with the three switching poles 1a, 1b, 1c, the three stationary contact pieces 2a, 2b, 2c and the three movable contact pieces 3a, 3b, 3c is used as the electrical switching device. The arrangement illustrated in FIG. 3 has a first drive device 4a and a second drive device 4b. The first drive device 4a is coupled to the movable contact pieces 3a, 3b, 3c via a common clutch 6d. When the clutch 6d is engaged, all three movable contact pieces 3a, 3b, 3c can be moved simultaneously. The drive device 4a therefore has dimensions such that all the movable contact pieces 3a, 3b, 3c can be moved jointly without any problems.

Furthermore, a second drive device 4b is provided which can be connected to the movable contact pieces 3a, 3b, 3c via three clutches 6e, 6f, 6g associated in each case with the movable contact pieces 3a, 3b, 3c. The clutches 6d, 6e, 6f, 6g in principle correspond to the clutches described in the exemplary embodiments above. When one or more of the clutches 6e, 6f, 6g is engaged, there is the possibility of moving one or more of the movable contact pieces 3a, 3b, 3c. Since in general the drive device 4b is used for moving a single one of the movable contact pieces 3a, 3b, 3c, the drive device 4b can be provided with smaller dimensions in terms of its power than the drive device 4a. This prevents a contact piece 3a, 3b, 3c to be moved individually being subject to too much drive energy and thus closing prematurely.

The clutches illustrated in FIGS. 1, 2 and 3 for transmitting a translatory movement can also be replaced by other clutches. In addition to the transmission of translatory movements, it is conventional in the drive technology of electrical switching devices to transmit rotary movements. In this case it is advantageous to use clutches which are suitable for transmitting a torque. These clutches may be, for example, magnetic clutches, friction clutches or interlocking clutches. FIG. 4 is a schematic illustration of an exemplary embodiment with torque-transmitting clutches.

A drive device 4e produces a rotary movement. This rotary movement is distributed over a gear 7. In the present embodiment, the gear 7 is a chain gear, in the case of which a chain connects a plurality of toothed wheels to one another, so that they move synchronously. The gear 7 has three output drive shafts, which act as connecting elements 5c, 5d, 5e. The connecting elements 5c, 5d, 5e can each be interrupted by means of a clutch 6h, 6i, 6j. In each case levers are arranged at the disconnectable parts of the connecting elements 5c, 5d, 5e, via which levers a rotary movement is converted into a translatory movement. The three movable contact pieces of three switching poles of an electrical switching device illustrated symbolically in FIG. 4 are moved by means of the translatory movements.

The manner in which the principle illustrated in FIG. 2 of a translatory movement was transferred to a rotary movement as shown in FIG. 4 can also be realized by the arrangements illustrated in FIGS. 1 and 3 with correspondingly rotatably mounted connecting elements and torque-transmitting clutches.

1-7. (canceled)

8. A drive configuration in an electrical switching device, comprising:
a drive device;
at least one connecting element connecting said drive device to a plurality of movable contact pieces of a plurality of switching poles of the electrical switching device; and
a clutch configured to disconnected said drive device from at least one of the contact pieces.

9. The drive configuration according to claim 8, wherein said clutch is an electromagnetically driven clutch.

10. The drive configuration according to claim 8, wherein said clutch is one of a plurality of separately driven clutches disposed to disconnect each of the contact pieces separately of one another.

11. The drive configuration according to claim 8, wherein all of the movable contact pieces are capable of moving jointly.

12. The drive configuration according to claim 8, wherein a contact piece of a switching pole is movable, while the contact pieces of other switching poles are decoupled from said drive device.

13. The drive configuration according to claim 8, wherein said drive device includes a first drive and a second drive and wherein said at least one clutch is mounted to selectively connect said first drive or said second drive to the movable contact pieces.

14. A method for operating a switching device with a plurality of movable contact pieces of a plurality of switching poles and a common drive device for moving the contact pieces, wherein the contact pieces are in their switched-on positions, the method which comprises:
moving a given one of the contact pieces into a switched-off position thereof;
retaining the other contact pieces at rest, decoupled from the drive device; and
moving the given contact piece from the switched-off position back into the switched-on position.
